(19) United States
(12) Patent Application Publication
(10) Pub. No.: US 2020/0267338 A1
(43) Pub. Date: Aug. 20, 2020

(54) IMAGE CAPTURING APPARATUS, IMAGE PROCESSING APPARATUS, CONTROL METHOD, IMAGE PROCESSING METHOD, AND STORAGE MEDIUM

(71) Applicant: CANON KABUSHIKI KAISHA, Tokyo (JP)

(72) Inventors: Takashi Gyotoku, Kawasaki-shi (JP); Hidetaka Uemura, Kawasaki-shi (JP)

(21) Appl. No.: 16/791,140

(22) Filed: Feb. 14, 2020

(30) Foreign Application Priority Data
Feb. 19, 2019 (JP) 2019-027654

(51) Int. Cl. H04N 5/359; G06T 7/20; G06T 5/00; H04N 5/213

(52) U.S. Cl. CPC H04N 5/359; H04N 5/213; G06T 5/002; G06T 7/20

(57) ABSTRACT

There is provided an image capturing apparatus having an image sensor. A control unit performs control such that image capture by the image sensor is repeatedly performed to generate a plurality of images. A generation unit generates a moving image obtained by arranging the plurality of images in order as a frame. Regarding at least one of the plurality of images, the generation unit repeatedly arranges each image in order as two or more continuous frames. A recording unit records the moving image in association with identification information identifying whether each frame of the moving image corresponds to a same image as an immediately previous frame.

### BACKGROUND OF THE INVENTION

### Field of the Invention

The present invention relates to an image capturing apparatus, an image processing apparatus, a control method, an image processing method, and a storage medium.

### Description of the Related Art

Recursive noise reduction processing (hereinafter, “recursive NR processing”) is a known technique. Recursive NR processing is processing that reduces noise by utilizing the correlation between the image of the current frame and the image of a frame at least one frame period prior thereto stored in memory. A recording apparatus of Japanese Patent Laid-Open No. 5-22696, at the time of recording a video signal, detects the correlation of continuous screens with a correlation detection circuit, and writes information of this correlation value to an index area. A playback apparatus, at the time of playback, then acquires correlation information of the continuous screens from a playback signal of the index area, and controls the amount of noise reduction, according to this correlation information.

Also, normal shutter control as shown in FIG. 2A and slow shutter control as shown in FIG. 2B are known as shutter controls that are performed at the time of moving image recording. In the case of slow shutter control, the frame corresponding to the storage timing is substantively a repeat of the immediately previous frame. Thus, the frame corresponding to the storage timing is very highly correlated with the immediately previous frame.

Japanese Patent Laid-Open No. 5-22696 does not take the case where slow shutter control is performed into consideration. Thus, in the case where the technology of Japanese Patent Laid-Open No. 5-22696 is applied to moving image recording performed under slow shutter control, correlation detection processing is also performed on frames corresponding to the storage timing. Since the correlation detection processing has a comparatively high processing load, performing correlation detection processing on the frame corresponding to the storage timing despite the correlation clearly being very high leads to a meaningless increase in power consumption.

### SUMMARY OF THE INVENTION

The present invention has been made in view of such a situation. The present invention provides a technology that makes it possible to control recursive NR processing according to whether a frame for processing is a repeat of an immediately previous frame at the time of moving image playback, while suppressing an increase in processing load at the time of moving image recording and moving image playback.

According to a first aspect of the present invention, there is provided an image capturing apparatus comprising: an image sensor; and at least one processor and/or at least one circuit which functions as: a control unit configured to perform control such that image capture by the image sensor is repeatedly performed to generate a plurality of images; a generation unit configured to generate a moving image obtained by arranging the plurality of images in order as a frame, wherein regarding at least one of the plurality of images, the generation unit repeatedly arranges each image in order as two or more continuous frames; and a recording unit configured to record the moving image in association with identification information identifying whether each frame of the moving image corresponds to a same image as an immediately previous frame.

According to a second aspect of the present invention, there is provided an image processing apparatus comprising at least one processor and/or at least one circuit which functions as: an acquisition unit configured to acquire a moving image and identification information identifying whether each frame of the moving image corresponds to a same image as an immediately previous frame; a determination unit configured to determine, for each frame of the moving image, whether the frame corresponds to the same image as the immediately previous frame, based on the identification information; and an image processing unit configured to apply recursive noise reduction processing to each frame of the moving image, the image processing unit changing a weight of a frame for processing in the recursive noise reduction processing according to whether the frame for processing corresponds to the same image as the immediately previous frame.

According to a third aspect of the present invention, there is provided an image processing apparatus comprising at least one processor and/or at least one circuit which functions as: an acquisition unit configured to acquire a moving image and information indicating a frame rate and a shutter speed of the moving image; a determination unit configured to determine, for each frame of the moving image, whether the frame corresponds to a same image as an immediately previous frame, based on the frame rate and the shutter speed; and an image processing unit configured to apply recursive noise reduction processing to each frame of the moving image, the image processing unit changing a weight of a frame for processing in the recursive noise reduction processing according to whether the frame for processing corresponds to the same image as the immediately previous frame.

According to a fourth aspect of the present invention, there is provided an image processing apparatus comprising at least one processor and/or at least one circuit which functions as: an acquisition unit configured to acquire a moving image and metadata associated with the moving image; a determination unit configured to determine, for each frame of the moving image, whether the frame corresponds to a same image as an immediately previous frame, based on the metadata; and an image processing unit configured to apply recursive noise reduction processing to each frame of the moving image, the image processing unit changing a weight of a frame for processing in the recursive noise reduction processing according to whether the frame for processing corresponds to the same image as the immediately previous frame, wherein the determination unit is configured to, in a case where the metadata includes identification information identifying whether each frame of the moving image corresponds to the same image as the immediately previous frame, determine, for each frame of the moving image, whether the frame corresponds to the same image as the immediately previous frame, based on the identification information, and the determination unit is configured to, in a case where the metadata does not include the identification information and the metadata includes information indicating a frame rate and a shutter speed of the moving image, determine, for each frame of the moving image, whether the frame corresponds to the same image as the immediately previous frame, based on the frame rate and the shutter speed.

According to a fifth aspect of the present invention, there is provided a control method executed by an image capturing apparatus having an image sensor, the method comprising: performing control such that image capture by the image sensor is repeatedly performed to generate a plurality of images; generating a moving image obtained by arranging the plurality of images in order as a frame, wherein regarding at least one of the plurality of images, each image is repeatedly arranged in order as two or more continuous frames; and recording the moving image in association with identification information identifying whether each frame of the moving image corresponds to a same image as an immediately previous frame.

According to a sixth aspect of the present invention, there is provided an image processing method executed by an image processing apparatus, comprising: acquiring a moving image and identification information identifying whether each frame of the moving image corresponds to a same image as an immediately previous frame; determining, for each frame of the moving image, whether the frame corresponds to the same image as the immediately previous frame, based on the identification information; and applying recursive noise reduction processing to each frame of the moving image, wherein a weight of a frame for processing in the recursive noise reduction processing is changed according to whether the frame for processing corresponds to the same image as the immediately previous frame.

According to a seventh aspect of the present invention, there is provided an image processing method executed by an image processing apparatus, comprising: acquiring a moving image and information indicating a frame rate and a shutter speed of the moving image; determining, for each frame of the moving image, whether the frame corresponds to a same image as an immediately previous frame, based on the frame rate and the shutter speed; and applying recursive noise reduction processing to each frame of the moving image, wherein a weight of a frame for processing in the recursive noise reduction processing is changed according to whether the frame for processing corresponds to the same image as the immediately previous frame.

According to an eighth aspect of the present invention, there is provided an image processing method executed by an image processing apparatus, comprising: acquiring a moving image and metadata associated with the moving image; determining, for each frame of the moving image, whether the frame corresponds to a same image as an immediately previous frame, based on the metadata; and applying recursive noise reduction processing to each frame of the moving image, wherein a weight of a frame for processing in the recursive noise reduction processing is changed according to whether the frame for processing corresponds to the same image as the immediately previous frame, wherein in a case where the metadata includes identification information identifying whether each frame of the moving image corresponds to the same image as the immediately previous frame, for each frame of the moving image, whether the frame corresponds to the same image as the immediately previous frame is determined based on the identification information, and in a case where the metadata does not include the identification information and the metadata includes information indicating a frame rate and a shutter speed of the moving image, for each frame of the moving image, whether the frame corresponds to the same image as the immediately previous frame is determined based on the frame rate and the shutter speed.

According to a ninth aspect of the present invention, there is provided a non-transitory computer-readable storage medium which stores a program for causing a computer to execute a control method comprising: performing control such that image capture by an image sensor is repeatedly performed to generate a plurality of images; generating a moving image obtained by arranging the plurality of images in order as a frame, wherein regarding at least one of the plurality of images, each image is repeatedly arranged in order as two or more continuous frames; and recording the moving image in association with identification information identifying whether each frame of the moving image corresponds to a same image as an immediately previous frame.

According to a tenth aspect of the present invention, there is provided a non-transitory computer-readable storage medium which stores a program for causing a computer to execute an image processing method comprising: acquiring a moving image and identification information identifying whether each frame of the moving image corresponds to a same image as an immediately previous frame; determining, for each frame of the moving image, whether the frame corresponds to the same image as the immediately previous frame, based on the identification information; and applying recursive noise reduction processing to each frame of the moving image, wherein a weight of a frame for processing in the recursive noise reduction processing is changed according to whether the frame for processing corresponds to the same image as the immediately previous frame.

According to an eleventh aspect of the present invention, there is provided a non-transitory computer-readable storage medium which stores a program for causing a computer to execute an image processing method comprising: acquiring a moving image and information indicating a frame rate and a shutter speed of the moving image; determining, for each frame of the moving image, whether the frame corresponds to a same image as an immediately previous frame, based on the frame rate and the shutter speed; and applying recursive noise reduction processing to each frame of the moving image, wherein a weight of a frame for processing in the recursive noise reduction processing is changed according to whether the frame for processing corresponds to the same image as the immediately previous frame.

According to a twelfth aspect of the present invention, there is provided a non-transitory computer-readable storage medium which stores a program for causing a computer to execute an image processing method comprising: acquiring a moving image and metadata associated with the moving image; determining, for each frame of the moving image, whether the frame corresponds to a same image as an immediately previous frame, based on the metadata; and applying recursive noise reduction processing to each frame of the moving image, wherein a weight of a frame for processing in the recursive noise reduction processing is changed according to whether the frame for processing corresponds to the same image as the immediately previous frame, wherein in a case where the metadata includes identification information identifying whether each frame of the moving image corresponds to the same image as the immediately previous frame, for each frame of the moving image, whether the frame corresponds to the same image as the immediately previous frame is determined based on the identification information, and in a case where the metadata does not include the identification information and the metadata includes information indicating a frame rate and a shutter speed of the moving image, for each frame of the moving image, whether the frame corresponds to the same image as the immediately previous frame is determined based on the frame rate and the shutter speed.

Further features of the present invention will become apparent from the following description of exemplary embodiments with reference to the attached drawings.

### BRIEF DESCRIPTION OF THE DRAWINGS

FIG. 1 is a block diagram of an image capturing apparatus 100.

FIG. 2A is a conceptual view of normal shutter control.

FIG. 2B is a conceptual view of slow shutter control.

FIG. 3 is a flowchart of frame recording processing according to a first embodiment.

FIGS. 4A and 4B are conceptual views of RAW moving image recording processing according to the first embodiment.

FIG. 5 is a flowchart of development processing according to the first embodiment.

FIG. 6 is a diagram showing an example of identification information identifying whether each frame corresponds to the same image as an immediately previous frame.

FIG. 7 is a flowchart of development processing according to a second embodiment.

FIGS. 8A and 8B are conceptual views of RAW moving image playback processing according to the second embodiment.

FIG. 9 is a diagram showing a correspondence relationship between frame rate, shutter speed and stored frame count.

FIG. 10 is a flowchart of development processing according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

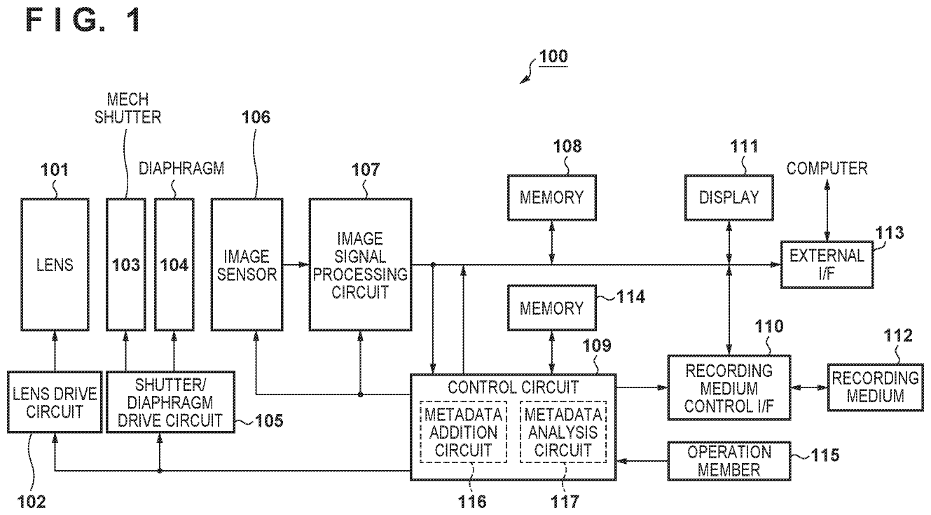

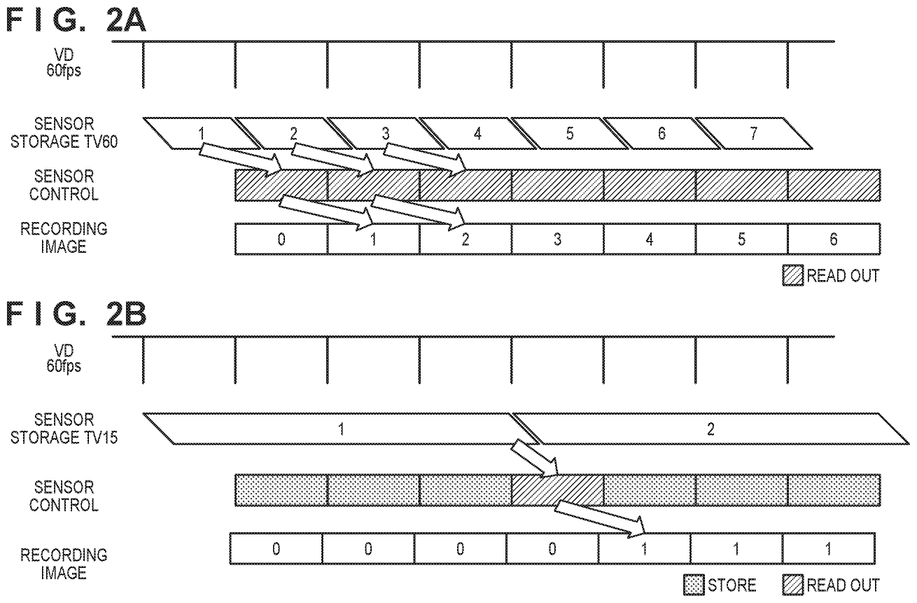

FIG. 1 is a block diagram of an image capturing apparatus 100. In FIG. 1, reference numeral 101 denotes a lens, 102 denotes a lens drive circuit, 103 denotes a mechanical shutter hereinafter, “mech shutter”), 104 denotes a diaphragm, and 105 denotes a mechanical shutter and diaphragm drive circuit (hereinafter, “shutter/diaphragm drive circuit”). Reference numeral 106 denotes an image sensor, 107 denotes an image signal processing circuit, 108 denotes a memory, 109 denotes a control circuit, and 110 denotes a recording medium control interface (hereinafter, “recording medium control Up”). Reference numeral 111 denotes a display, 112 denotes a recording medium, 113 denotes an external interface (hereinafter, “external I/F”), 114 denotes a memory, and 115 denotes an operation member.

Drive control of zooming, focusing and the like the lens 101 is performed by the lens drive circuit 102. An object image that has passed through the lens 101 is adjusted to an appropriate light amount by the diaphragm 104, and an image is formed on an image forming surface of the image sensor 106. The object image formed on the image forming surface of the image sensor 106 undergoes photoelectrical conversion, and further undergoes gain adjustment and AID conversion for conversion from analog signals to digital signals. The digital signals thus obtained are sent to the image signal processing circuit 107 as R, Gr, Gb and B signals. The image signal processing circuit 107 performs various image signal processing such as development processing, low-pass filter processing for reducing noise, shading processing, white balance (WB) processing and recursive NR processing, and further performs various correction, compression of image data, and the like.

Drive control of the mech shutter 103 and the diaphragm 104 is performed by the shutter/diaphragm drive circuit 105. The control circuit 109 performs overall control of the image capturing apparatus 100 and various computational operations. The memory 108 temporarily stores image data. The recording medium control I/F 110 performs recording or reading out of image data with respect to the recording medium 112. The display 111 displays image data. The recording medium 112 is a removable recording medium such as a semiconductor memory, and records image data. The external I/F 113 is an interface for performing communication with external computers and the like. The memory 114 stores the results of computational operations performed by the control circuit 109.

Information relating to drive conditions of the image capturing apparatus 100 set by the user via the operation member 115 is sent to the control circuit 109, and overall control of the image capturing apparatus 100 is performed based on this information. A metadata addition circuit 116, at the time of recording image data to the recording medium 112 via the recording medium control 110, adds metadata to the image data. A metadata analysis circuit 117 acquires metadata from image data read out from the recording medium 112 via the recording medium control I/F 110, and analyzes the metadata.

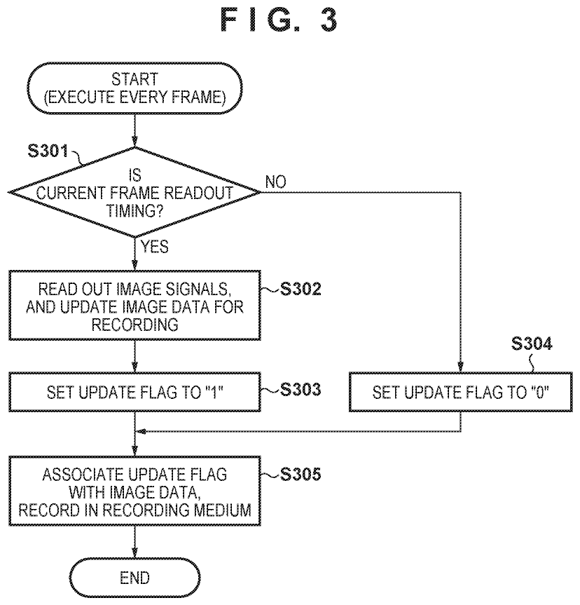

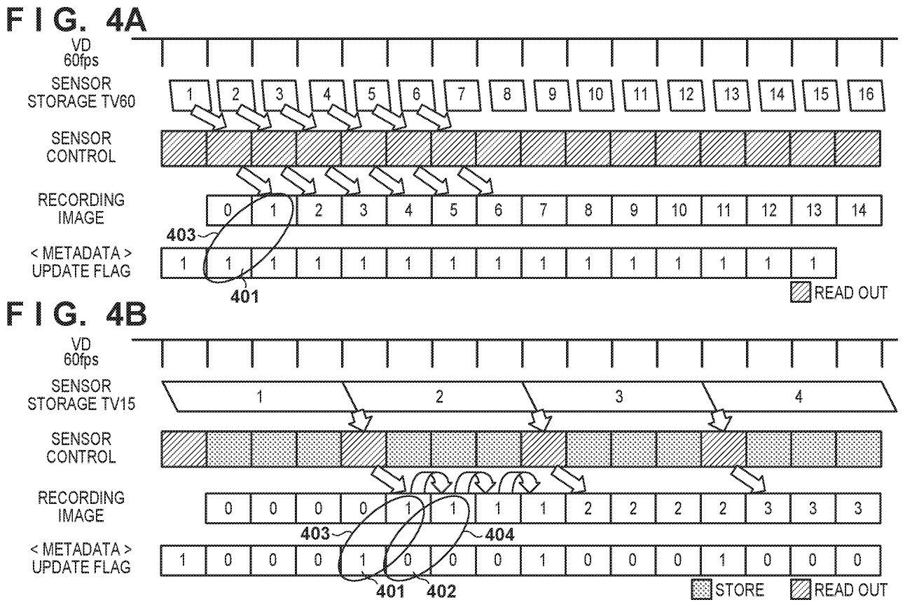

Next, RAW moving image recording processing according to the first embodiment will be described, with reference to FIG. 3 and FIGS. 4A and 4B. FIG. 3 is a flowchart of frame recording processing that the image capturing apparatus 100 executes every frame at the time of RAW moving image recording, and FIGS. 4A and 4B are conceptual views of the RAW moving image recording processing. Processing of the steps of the flowchart in FIG. 3 is realized by the control circuit 109 controlling the units of the image capturing apparatus 100 in accordance with a control program, unless stated otherwise. When the user gives an instruction to start recording of a RAW moving image using the operation member 115, the control circuit 109 starts exposure control of the image sensor 106 in accordance with exposure settings, and executes the processing of this flowchart every frame.

In step S301, the control circuit 109 determines whether current frame is a readout timing (timing for reading out image signals from the image sensor 106). For example, in the case where a shutter speed TV is 1/60 seconds (or faster) as shown in FIG. 4A, every frame is the readout timing. Also, in the case where the shutter speed TV is 1/15 seconds as shown in FIG. 4B, sensor storage (storage of electric charge in the image sensor 106) is performed over four frames, and thus the readout timing is once every four frames. If the current frame is the readout timing, the processing proceeds to step S302, and, if not the readout timing, the processing proceeds to step S304.

In step S302, the control circuit 109 generates RAW image data in a Bayer array by reading out image signals from the image sensor 106 and inputting the image signals to the image signal processing circuit 107, and temporarily stores the RAW image data in the memory 108 as image data for recording. The image data for recording is thereby updated from image data obtained at the immediately previous readout timing to image data obtained at the current readout timing.

In step S303, the metadata addition circuit 116 sets an update flag that is stored in the memory 114 to “1”. The update flag is a flag (identification information) indicating whether the current frame is an update frame (frame corresponding to a different image to the immediately previous frame) or a non-update frame (frame corresponding to the same image as the immediately previous frame). Update flag “1” indicates an update frame and update flag “0” indicates a non-update frame.

On the other hand, if it is determined in step S301 that the current frame is not the readout timing, the metadata addition circuit 116, in step S304, sets the update flag that is stored in the memory 114 to “0”.

Following the processing of step S303 or step S304, the control circuit 109, in step S305, records the image data that is stored in the memory 108 to the recording medium 112 via the recording medium control I/F 110 as the frame of a moving image. Also, the control circuit 109 associates metadata including the update flag that is stored in the memory 114 with the current frame, and records the resultant data in the recording medium 112 via the recording medium control I/F 110.

By executing the above processing every frame during moving image recording, a moving image in which an update flag is associated with each frame is generated. For example, in the case where the shutter speed is 1/60 seconds (or faster) as shown in FIG. 4A, all frames will be update frames, and metadata including update flag “1” is associated therewith (refer to update flag 401 included in an association 403 in FIG. 4A). On the other hand, in the case where the shutter speed is 1/15 seconds as shown in FIG. 4B, the image data for recording (recording image) is updated only once every four frames, and the same recording image is repeatedly arranged in order in the remaining three frames. Accordingly, the metadata update flag will be “1” for only the frame corresponding to the readout timing (refer to the update flag 401 included in the association 403 in FIG. 4B). The update flags of the remaining three frames will be “0” (refer to the update flag 402 included in an association 404 in FIG. 4B).

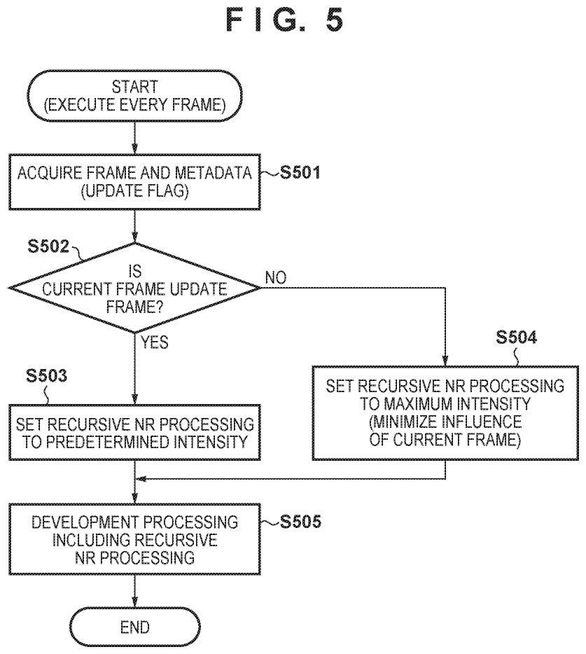

Next, RAW moving image playback processing according to the first embodiment will be described, with reference to FIG. 5. FIG. 5 is a flowchart of development processing that the image capturing apparatus 100 executes every frame at the time of RAW moving image playback. The processing of the steps of this flowchart is realized by the control circuit 109 controlling the units of the image capturing apparatus 100 in accordance with a control program, unless stated otherwise. When the user selects a RAW moving image for playback using the operation member 115 and gives an instruction to start playback, the control circuit 109 executes the processing of this flowchart every frame.

In step S501, the control circuit 109 reads out one frame from the RAW moving image file recorded on the recording medium 112 via the recording medium control I/F 110, and acquires associated metadata.

In step S502, the metadata analysis circuit 117 analyzes the metadata acquired in step S501, and determines whether the update flag is “1” (i.e., whether the current frame is an update frame). If the update flag is “1”, the processing proceeds to S503, and if the update flag is “0”, the processing proceeds to S504.

In step S503, the control circuit 109 sets a parameter of the recursive NR processing of the image signal processing circuit 107, such that the recursive NR processing is executed at a predetermined intensity. The parameter of the recursive NR processing is, for example, a weight of the current frame (frame for processing) in the recursive NR processing. The intensity is low if the weight is large, and the intensity is high if the weight is small. Note that with regard to the “predetermined intensity” referred to here, the image capturing apparatus 100 may, for example, record the intensity at which the recursive NR processing was performed at the time of shooting the current frame in the metadata and use this intensity as the intensity that is set in step S503, or may use an intensity that is determined in advance for use in playback. Alternatively, an intensity that is set according to whether there is a scene change between the current frame and the immediately previous frame or an intensity set according to an instruction by the user may be used.

On the other hand, if it is determined in step S502 that the update flag is “0”, the control circuit 109, in step S504, sets the parameter of the recursive NR processing of the image signal processing circuit 107 such that the recursive NR processing is executed at maximum intensity. The “maximum intensity” referred to here means an intensity unaffected by the current frame, that is, the previous frame after the recursive NR processing has been applied is directly output (weight of current frame is set to 0).

Note that the intensity setting in step S504 need only differ from the intensity setting in step S503, and need not necessarily be the maximum intensity. As long as the intensity setting differs between step S503 and step S504, the control circuit 109 can be said to execute control that changes the weight of the frame for processing in the recursive NR processing according to Whether the frame for processing corresponds to the same image as the immediately previous frame. In the case where the weight of the frame for processing is set to a small value (the intensity of recursive NR processing is set to a large value) in S504 compared with S503, the noise reduction effect on non-update frames increases.

Following the processing of step S503 or S504, the control circuit 109, in step S505, performs development processing on the image data of the current frame, using the image signal processing circuit 107, and displays the image data that has undergone development processing on the display 111. The development processing includes recursive NR processing performed in accordance with the intensity set in step S503 or S504. The recursive NR processing is performed with reference to the image data of the previous frame after the recursive NR processing has been applied.

By executing the above processing every frame during moving image playback, recursive NR processing appropriate to each frame is performed.

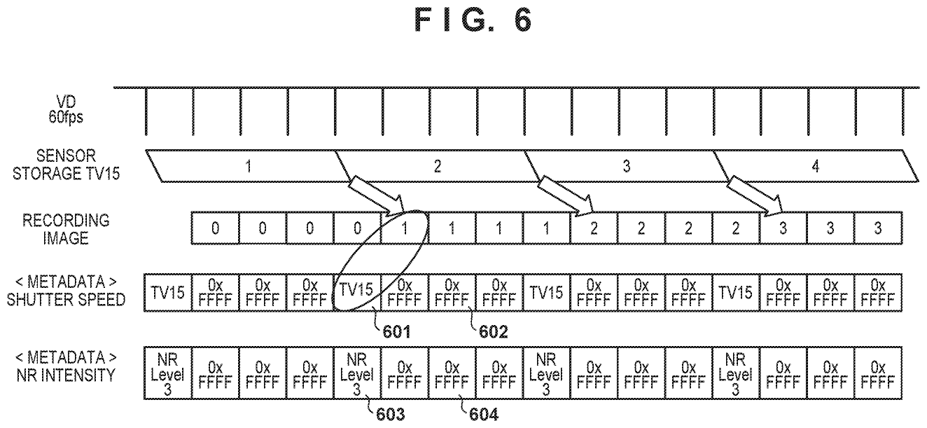

Note that, in the above description, a configuration was described in which an update flag is added to metadata as identification information identifying whether each frame corresponds to the same image as the immediately previous frame, but the identification information is not limited to an update flag. For example, as shown in FIG. 6, a specific item (setting value of shutter speed, intensity setting value of noise reduction processing, etc.) in existing metadata may be used as identification information. In the example in FIG. 6, in the case of using the shutter speed setting Value as identification information, shutter speed=“TV15” (denoted by reference numeral 601) is stored as the shutter speed setting value of update frames. Also, invalid value=“0xFFFF” (denoted by reference numeral 602) is stored as the shutter speed setting value of non-update frames. In this case, the image capturing apparatus 100 is able to determine whether the current frame is a non-update frame at the time of playback, based on whether the shutter speed setting value of the current frame is an invalid value. Similarly, in the case of using the intensity setting value of noise reduction processing as identification information, a predetermined setting value (e.g., “Level 3” (denoted by reference numeral 603)) is stored as the intensity setting value of update frames. Also, invalid value=“0xFFFF” (denoted by reference numeral 604) is stored as the intensity setting value of non-update frames. In this case, the image capturing apparatus 100 is able to determine whether the current frame is a non-update frame at the time of playback, based on whether the intensity setting value of the noise reduction processing of the current frame is an invalid value.

Also, in the above description, a configuration was described in which the recursive NR processing is executed on update frames at a predetermined intensity, and the recursive NR processing is executed on non-update frames at maximum intensity. However, in the case where the recording image clearly changes from the previous frame, such as color bar display or ON/OFF of electronic expansion of a digital teleconference or the like, for example, information indicating that recursive NR processing is not to be implemented may be stored in the metadata.

According to the first embodiment, as described above, the image capturing apparatus 100 repeatedly performs image capture to generate a plurality of images, and generates a moving image in which the plurality of images are arranged in order as a frame, as shown in FIG. 4B, for example. At this time, regarding at least one of the plurality of images, the image capturing apparatus 100 repeatedly arranges each image in order as two or more continuous frames. The image capturing apparatus 100 then records the moving image in association with identification information (e.g., update flags shown in FIG. 4B) identifying whether each frame of the moving image corresponds to the same image as the immediately previous frame. At the time of moving image playback, the image capturing apparatus 100 acquires the identification information together with the moving image, and applies recursive noise reduction processing to each frame of the moving image. At that time, the image capturing apparatus 100 changes the weight of the frame for processing in the recursive noise reduction processing, according to whether the frame for processing corresponds to the same image as the immediately previous frame. It thereby becomes possible to control the recursive NR processing according to whether the frame for processing is a repeat of the immediately previous frame at the time of moving image playback, while suppressing an increase in the processing load at the time of moving image recording and moving image play back.

### Second Embodiment

In the first embodiment, a configuration was described in which it is determined whether the current frame is an update frame, by referring to identification information such as an update flag at the time of RAW moving image playback. In contrast, in the second embodiment, a configuration will be described in which, rather than using identification information, an update cycle of frames is calculated based on the frame rate and shutter speed recorded in metadata, and it is determined whether the current frame is an update frame based on the update cycle. In the second embodiment, the basic configuration of the image capturing apparatus 100 is similar to the first embodiment (refer to FIG. 1). Hereinafter, description will focus on the differences from the first embodiment.

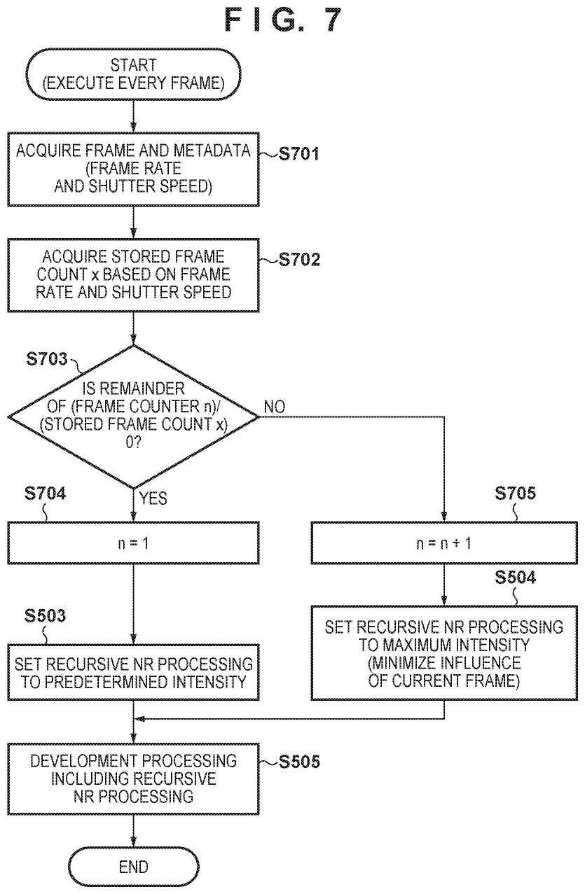

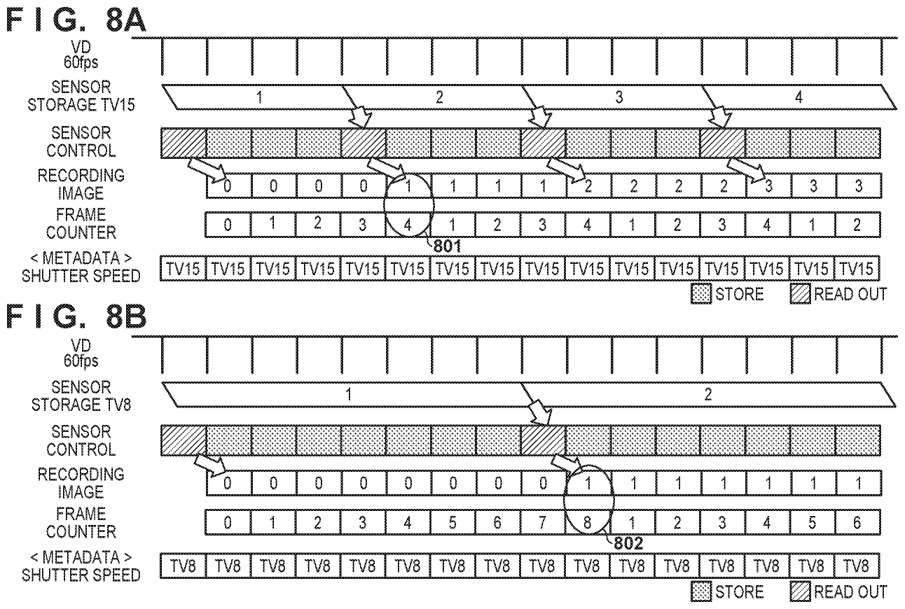

RAW moving image playback processing according to the second embodiment will be described, with reference to FIG. 7 and FIGS. 8A and 8B. FIG. 7 is a flowchart of development processing that the image capturing apparatus 100 executes every frame at the time of RAW moving image playback, and FIGS. 8A and 8B are conceptual views of the RAW moving image playback processing. The processing of the steps of the flowchart in FIG. 7 is realized by the control circuit 109 controlling the units of the image capturing apparatus 100 in accordance with a control program, unless stated otherwise. When the user selects a RAW moving image for playback using the operation member 115 and gives an instruction to start playback, the control circuit 109 executes the processing of this flowchart every frame.

In step S701, the control circuit 109 reads out one frame from the RAW moving image file recorded on the recording medium 112 via the recording medium control I/F 110, and acquires associated metadata. The metadata includes information indicating the frame rate and shutter speed.

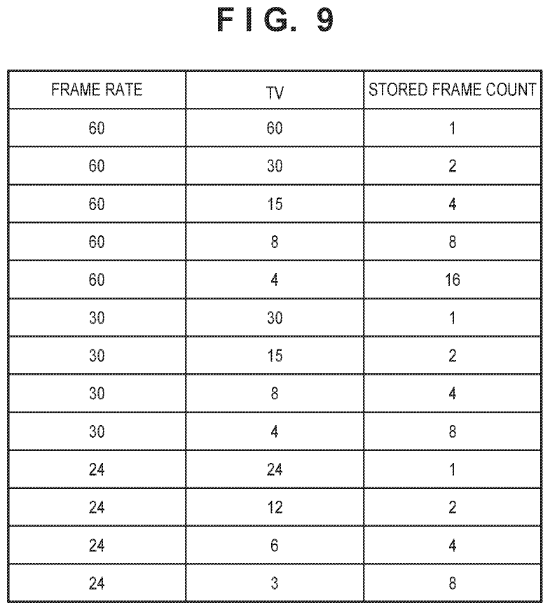

In step S702, the control circuit 109 acquires a stored frame count x, based on the frame rate and shutter speed indicated by the metadata. For example, a table showing the correspondence relationship between frame rate, shutter speed and stored frame count, such as shown in FIG. 9, is stored in advance in a nonvolatile memory included in the control circuit 109. The control circuit 109 acquires the stored frame count x with reference to this table.

In step S703, the control circuit 109 calculates the remainder of dividing a frame counter n by the stored frame count x acquired in step S702, and determines whether the remainder is 0. The frame counter n is initialized to 0 by the control circuit 109 at the start of moving image playback. If the remainder is 0, the processing proceeds to step S704, and, if not 0, the processing proceeds to step S705.

In step S704, the control circuit 109 substitutes 1 for the frame counter n. Thereafter, the processing of S503 and S505 is executed, similarly to the first embodiment.

On the other hand, if it is determined in step S703 that remainder of n/x is not 0, the control circuit 109, in step S705, adds 1 to the frame counter n. Thereafter, the processing of S504 and S505 is executed, similarly to the first embodiment.

By executing the above processing every frame during moving image playback, recursive NR processing appropriate to each frame is performed. For example, consider the case where the frame rate is 60 fps and the shutter speed is 1/15 seconds (TV15), as shown in FIG. 8A. In this case, in step S702, 4 is acquired as the stored frame count x in accordance with the table in FIG. 9. Accordingly, the remainder of n/x will be 0 if the frame counter n is a multiple of 4, as indicated by reference numeral 801 in FIG. 8A. That is, if the remainder of n/x is 0, the current frame is an update frame, and the recursive NR processing is set to the predetermined intensity in step S503. Also, if the frame counter is not a multiple of 4 (i.e., if the remainder of n/x is not 0), the current frame is a non-update frame, and the recursive NR processing is set to the maximum intensity in step S504. Similarly, if the frame rate is 60 fps and the shutter speed is 1/8 seconds (TV8), as shown in FIG. 8B, 8 is acquired in step S702 as the stored frame count x in accordance with the table in FIG. 9. Accordingly, the remainder of n/x will be 0, in the case where the frame counter n is a multiple of 8, as shown by the reference numeral 802 in FIG. 8B. That is, if the remainder of n/x is 0, the current frame is an update frame, and the recursive NR processing is set to the predetermined intensity in step S503. Also, if the frame counter is not a multiple of 8 (i.e., if the remainder of n/x is not 0), the current frame is a non-update frame, and the recursive NR processing is set to the maximum intensity in step S504.

Note that, in relation to the intensity of the recursive NR processing, control may be performed such that an intensity that differs from the intensity used at the time of recording is set in the case where recording was performed with a long exposure in which the shutter speed is slow, and such that the same intensity as the time of recording is set in the case where recording was performed with a normal exposure with respect to the frame rate.

Also, in the above description, the frame counter n is assumed to return to 1 every stored frame count x (refer to steps S703 and S704 in FIG. 7), However, the frame counter may be consecutive number, as long as control is performed such that shutter speed is only changed in even numbered frames, with consideration for the interlace format, for example.

According to the second embodiment, as described above, the image capturing apparatus 100 determines whether the current frame is an update frame, based on the frame rate and shutter speed recorded in metadata. Even in the case where identification information is not recorded at the time of moving image recording, it thereby becomes possible to control the recursive NR processing at the time of moving image playback according to whether the frame for processing is a repeat of the immediately previous frame.

### Third Embodiment

The third embodiment describes a configuration in which control of recursive NR processing is switched according to the contents of metadata associated with the RAW moving image for playback. In the third embodiment, the basic configuration of the image capturing apparatus 100 is similar to the first embodiment and the second embodiment (refer to FIG. 1). Hereinafter, description will focus on the differences from the first embodiment and the second embodiment.

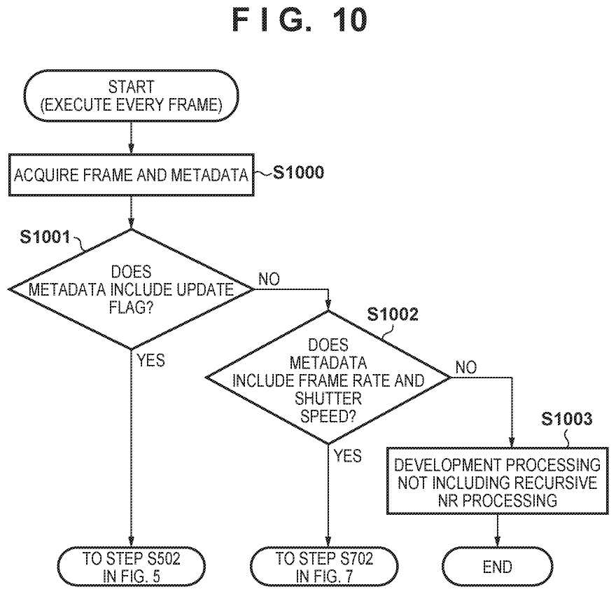

RAW moving image playback processing according to the third embodiment will be described, with reference to FIG. 10. FIG. 10 is a flowchart of development processing that the image capturing apparatus 100 executes every frame at the time of RAW moving image playback. The processing of the steps of this flowchart is realized by the control circuit 109 controlling the units of the image capturing apparatus 100 in accordance with a control program, unless stated otherwise. When the user selects a RAW moving image for playback using the operation member and gives an instruction to start playback, the control circuit 109 executes the processing of this flowchart every frame.

in step S1000, the control circuit 109 reads out one frame from the RAW moving image file recorded on the recording medium 112 via the recording medium control I/F 110, and acquires associated metadata.

In step S1001, the metadata analysis circuit 117 determines whether an update flag is included in the metadata of the current frame. If an update flag is included in the metadata, the processing proceeds to step S502 in FIG. 5, where the control circuit 109 executes the recursive NR processing described in the first embodiment on the current frame. If an update flag is not included in metadata, the processing proceeds to step S1002.

In step S1002, the metadata analysis circuit 117 determines whether information indicating the frame rate and shutter speed is included in the metadata of the current frame. If information indicating the frame rate and shutter speed is included in the metadata, the processing proceeds to step S702 in FIG. 7, where the control circuit 109 executes the recursive NR processing described in the second embodiment on the current frame. If information indicating the frame rate and shutter speed is not included in the metadata, the processing proceeds to step S1003.

In step S1003, the control circuit 109 performs development processing on the image data of the current frame, using the image signal processing circuit 107, and displays the image data that has undergone development processing on the display 111. The development processing that is executed here differs from the development processing that is executed in S505 of FIG. 5 and FIG. 7, with recursive NR processing not being included.

By executing the above processing every frame during moving image playback, recursive NR processing appropriate to each frame is performed on frames that are identifiable as an update frame or a non-update frame based on metadata.

Note that a configuration may also be adopted in which determination of whether specific information is included in metadata is performed using version information of the metadata, instead of directly checking whether the specific information is included.

According to the third embodiment, as described above, the image capturing apparatus 100 switches control of recursive NR processing according to the contents of metadata associated with the RAW moving image for play back. Flexible control that depends on the contents of metadata thereby becomes possible.

### Other Embodiments

In the abovementioned embodiments, description was given taking the case where a RAW moving image is recorded and played back as an example, but the embodiments are not limited to RAW moving images. Even in the case of recording and playing back a moving image that has undergone development processing, the technology of the embodiments can be utilized in the case where recursive NR processing is performed at the time of moving image playback.

Also, in the abovementioned embodiments, description was given taking the case where the present invention is applied to an image capturing apparatus as an example, but the embodiments are not limited to this example. The present invention is applicable to any device provided with an image sensor. That is, the present invention is applicable to any apparatus capable of capturing images, such as a mobile phone terminal, a portable image viewer, a camera-equipped television, a digital photo frame, a music player, a game machine and an electronic book reader. The invention relating to a configuration for playing back moving images in the abovementioned embodiments is also applicable to an image processing apparatus that does not have a function of capturing images.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-027654, filed Feb. 19, 2019, which is hereby incorporated by reference herein in its entirety.

What is claimed is:

1. An image capturing apparatus comprising:
an image sensor; and
at least one processor and/or at least one circuit which functions as:
a control unit configured to perform control such that image capture by the image sensor is repeatedly performed to generate a plurality of images;
a generation unit configured to generate a moving image obtained by arranging the plurality of images in order as a frame, wherein regarding at least one of the plurality of images, the generation unit repeatedly arranges each image in order as two or more continuous frames; and
a recording unit configured to record the moving image in association with identification information identifying whether each frame of the moving image corresponds to a same image as an immediately previous frame.

2. The image capturing apparatus according to claim 1,
wherein the recording unit is configured to associate, as the identification information, with each frame of the moving image, a flag indicating whether the frame corresponds to the same image as the immediately previous frame or corresponds to a different image.

3. The image capturing apparatus according to claim 1,
wherein the recording unit is configured to associate, as the identification information, with each frame, corresponding to a different image to the immediately previous frame, among the frames included in the moving image, a value indicating invalid shutter speed.

4. An image processing apparatus comprising at least one processor and/or at least one circuit which functions as:
an acquisition unit configured to acquire a moving image and identification information identifying whether each frame of the moving image corresponds to a same image as an immediately previous frame;
a determination unit configured to determine, for each frame of the moving image, whether the frame corresponds to the same image as the immediately previous frame, based on the identification information; and
an image processing unit configured to apply recursive noise reduction processing to each frame of the moving image, the image processing unit changing a weight of a frame for processing in the recursive noise reduction processing according to whether the frame for processing corresponds to the same image as the immediately previous frame.

5. The image processing apparatus according to claim 4,
wherein the image processing unit is configured to, in a case where the frame for processing corresponds to the same image as the immediately previous frame, reduce the weight of the frame for processing in the recursive noise reduction processing to less than a case where the frame for processing corresponds to a different image to the immediately previous frame.

6. The image processing apparatus according to claim 5,
wherein the image processing unit is configured to, in a case where the frame for processing corresponds to the same image as the immediately previous frame, set the weight of the frame for processing in the recursive noise reduction processing to 0.

7. An image processing apparatus comprising at least one processor and/or at least one circuit which functions as:
an acquisition unit configured to acquire a moving image and information indicating a frame rate and a shutter speed of the moving image;
a determination unit configured to determine, for each frame of the moving image, whether the frame corresponds to a same image as an immediately previous frame, based on the frame rate and the shutter speed; and
an image processing unit configured to apply recursive noise reduction processing to each frame of the moving image, the image processing unit changing a weight of a frame for processing in the recursive noise reduction processing according to whether the frame for processing corresponds to the same image as the immediately previous frame.

8. The image processing apparatus according to claim 7,
wherein the determination unit is configured to acquire a frame count corresponding to one image capture, based on the frame rate and the shutter speed, and determine, for each frame of the moving image, whether the frame corresponds to the same image as the immediately previous frame, based on the frame count.

9. The image processing apparatus according to claim 7,
wherein the image processing unit is configured to, in a case where the frame for processing corresponds to the same image as the immediately previous frame, reduce the weight of the frame for processing in the recursive noise reduction processing to less than a case where the frame for processing corresponds to a different image to the immediately previous frame.

10. The image processing apparatus according to claim 9,
wherein the image processing unit is configured to, in a case where the frame for processing corresponds to the same image as the immediately previous frame, set the weight of the frame for processing in the recursive noise reduction processing to 0.

11. An image processing apparatus comprising at least one processor and/or at least one circuit which functions as:
an acquisition unit configured to acquire a moving image and metadata associated with the moving image;
a determination unit configured to determine, for each frame of the moving image, whether the frame corresponds to a same image as an immediately previous frame, based on the metadata; and
an image processing unit configured to apply recursive noise reduction processing to each frame of the moving image, the image processing unit changing a weight of a frame for processing in the recursive noise reduction processing according to whether the frame for processing corresponds to the same image as the immediately previous frame,
wherein the determination unit is configured to, in a case where the metadata includes identification information identifying whether each frame of the moving image corresponds to the same image as the immediately previous frame, determine, for each frame of the moving image, whether the frame corresponds to the same image as the immediately previous frame, based on the identification information, and
the determination unit is configured to, in a case where the metadata does not include the identification information and the metadata includes information indicating a frame rate and a shutter speed of the moving image, determine, for each frame of the moving image, whether the frame corresponds to the same image as the immediately previous frame, based on the frame rate and the shutter speed.

12. The image processing apparatus according to claim 11,
wherein the image processing unit is configured to, in a case where the frame for processing corresponds to the same image as the immediately previous frame, reduce the weight of the frame for processing in the recursive noise reduction processing to less than a case where the frame for processing corresponds to a different image to the immediately previous frame.

13. The image processing apparatus according to claim 12,
wherein the image processing unit is configured to, in a case where the frame for processing corresponds to the same image as the immediately previous frame, set the weight of the frame for processing in the recursive noise reduction processing to 0.

14. A control method executed by an image capturing apparatus having an image sensor, the method comprising:
performing control such that image capture by the image sensor is repeatedly performed to generate a plurality of images;
generating a moving image obtained by arranging the plurality of images in order as a frame, wherein regarding at least one of the plurality of images, each image is repeatedly arranged in order as two or more continuous frames; and
recording the moving image in association with identification information identifying whether each frame of the moving image corresponds to a same image as an immediately previous frame.

15. An image processing method executed by an image processing apparatus, comprising:
acquiring a moving image and identification information identifying whether each frame of the moving image corresponds to a same image as an immediately previous frame;
determining, for each frame of the moving image, whether the frame corresponds to the same image as the immediately previous frame, based on the identification information; and
applying recursive noise reduction processing to each frame of the moving image, wherein a weight of a frame for processing in the recursive noise reduction processing is changed according to whether the frame for processing corresponds to the same image as the immediately previous frame.

16. An image processing method executed by an image processing apparatus, comprising:
acquiring a moving image and information indicating a frame rate and a shutter speed of the moving image;
determining, for each frame of the moving image, whether the frame corresponds to a same image as an immediately previous frame, based on the frame rate and the shutter speed; and
applying recursive noise reduction processing to each frame of the moving image, wherein a weight of a frame for processing in the recursive noise reduction processing is changed according to whether the frame for processing corresponds to the same image as the immediately previous frame.

17. An image processing method executed by an image processing apparatus, comprising:
acquiring a moving image and metadata associated with the moving image;
determining, for each frame of the moving image, whether the frame corresponds to a same image as an immediately previous frame, based on the metadata; and
applying recursive noise reduction processing to each frame of the moving image, wherein a weight of a frame for processing in the recursive noise reduction processing is changed according to whether the frame for processing corresponds to the same image as the immediately previous frame,
wherein in a case where the metadata includes identification information identifying whether each frame of the moving image corresponds to the same image as the immediately previous frame, for each frame of the moving image, whether the frame corresponds to the same image as the immediately previous frame is determined based on the identification information, and
in a case where the metadata does not include the identification information and the metadata includes information indicating a frame rate and a shutter speed of the moving image, for each frame of the moving image, whether the frame corresponds to the same image as the immediately previous frame is determined based on the frame rate and the shutter speed.

18. A non-transitory computer-readable storage medium which stores a program for causing a computer to execute a control method comprising:
performing control such that image capture by an image sensor is repeatedly performed to generate a plurality of images;
generating a moving image obtained by arranging the plurality of images in order as a frame, wherein regarding at least one of the plurality of images, each image is repeatedly arranged in order as two or more continuous frames; and
recording the moving image in association with identification information identifying whether each frame of the moving image corresponds to a same image as an immediately previous frame.

19. A non-transitory computer-readable storage medium which stores a program for causing a computer to execute an image processing method comprising:
acquiring a moving image and identification information identifying whether each frame of the moving image corresponds to a same image as an immediately previous frame;
determining, for each frame of the moving image, whether the frame corresponds to the same image as the immediately previous frame, based on the identification information; and
applying recursive noise reduction processing to each frame of the moving image, wherein a weight of a frame for processing in the recursive noise reduction processing is changed according to whether the frame for processing corresponds to the same image as the immediately previous frame.

20. A non-transitory computer-readable storage medium which stores a program for causing a computer to execute an image processing method comprising:
acquiring a moving image and information indicating a frame rate and a shutter speed of the moving image;
determining, for each frame of the moving image, whether the frame corresponds to a same image as an immediately previous frame, based on the frame rate and the shutter speed; and
applying recursive noise reduction processing to each frame of the moving image, wherein a weight of a frame for processing in the recursive noise reduction processing is changed according to whether the frame for processing corresponds to the same image as the immediately previous frame.

21. A non-transitory computer-readable storage medium which stores a program for causing a computer to execute an image processing method comprising:
acquiring a moving image and metadata associated with the moving image;
determining, for each frame of the moving image, whether the frame corresponds to a same image as an immediately previous frame, based on the metadata; and
applying recursive noise reduction processing to each frame of the moving image, wherein a weight of a frame for processing in the recursive noise reduction processing is changed according to whether the frame for processing corresponds to the same image as the immediately previous frame,
wherein in a case where the metadata includes identification information identifying whether each frame of the moving image corresponds to the same image as the immediately previous frame, for each frame of the moving image, whether the frame corresponds to the same image as the immediately previous frame is determined based on the identification information, and
in a case where the metadata does not include the identification information and the metadata includes information indicating a frame rate and a shutter speed of the moving image, for each frame of the moving image, whether the frame corresponds to the same image as the immediately previous frame is determined based on the frame rate and the shutter speed.
